(19) United States
(12) Patent Application Publication
(10) Pub. No.: US 2005/0024380 A1
(43) Pub. Date: Feb. 3, 2005

(54) Method for reducing random access memory of IC in display devices

(76) Inventors: Lin Lin, Taichung City (TW); Chih-Chang Lai, Taiping City (TW); Yung-Li Hsu, Taichung City (TW)

Correspondence Address: BIRCH STEWART KOLASCH & BIRCH, PO BOX 747, FALLS CHURCH, VA, 22040-0747, US

(21) Appl. No.: 10/627,763

(22) Filed: Jul. 28, 2003

(51) Int. Cl. G09G 5/02

(52) U.S. Cl. 345/600

(57) ABSTRACT

A method for reducing random access memory (RAM) of an IC in display devices includes transforming a digital signal of a graphic data of three original colors (R, G, B) to digital signals of Y:Cb:Cr; taking one sample from two sample ratios of Y:Cb:Cr (4:2:0) or Y:Cb:Cr (4:2:2); storing in the RAM of a driving IC to reduce the RAM usage (with compressible data); then transforming the Y:Cb:Cr signals to three original colors (R, G, B) signal format to output image data, wherein Y represents brightness signal, and Cb and Cr represent color signals.

### FIELD OF THE INVENTION

The present invention relates to a method for reducing RAM (random access memory) of IC in display devices and particularly to a method for reducing usage of RAM in the driving IC of display devices to lower price.

### BACKGROUND OF THE INVENTION

In the present techniques, for display devices to display image data, first, the image graphic data must be stored in a RAM of the driving IC of the display devices, then the display screen is activated to display the image.

Large image graphic data will take a lot of RAM space of the driving IC. As each set of pixel of the image graphic data is composed of three original colors (R [symbol] G [symbol] B) that include eight bits of red color (8 bits R), eight bits of green color (8 bits G), and eight bits of blue color (8 bits B) (as shown in FIG. 1) that are stored in the RAM of the driving IC, these data occupy too much RAM space in the driving IC. In severe cases, displaying the image becomes not possible, and more RAM is required.

To remedy the problem set forth above, some vendors have developed an apparatus and method to control updating of the RAM (that stores coding data to activate one or more LCD character and numeral pixels). This method has a drawback that is limited to character controlling.

U.S. Patent publication No. 2002/0015110 A1 discloses another method and apparatus to smooth the image and enhance resolution. The apparatus is complex.

U.S. Pat. No. 6,198,467, entitled “Method of displaying a high resolution digital color image on a low resolution dot-matrix display with high fidelity” discloses yet another method which employs a simple sampling method that results in distorted images.

U.S. Pat. No. 6,181,318, entitled “Apparatus and method for converting the resolution an image to a resolution of LCD monitor”, assigned to Samsung Co., proposes a method that uses a complicated data transformation method and results in significant system delay.

### SUMMARY OF THE INVENTION

The primary object of the invention is to resolve the aforesaid disadvantages and eliminate the shortcomings of the prior art. The invention processes every pixel of image graphic data, then stores in the RAM of the driving IC in the display device to reduce the RAM space required in the driving IC. Thus more RAM space of the driving IC may be allocated to store larger or more image graphic data.

In order to achieve the foregoing object, the method of the invention includes: transforming a graphic data of three original colors (R, G, B) to Y: Cb: Cr digital signals (Y: signal of brightness; Cb and Cr: color signals); selecting one sample from two sample ratios of Y: Cb: Cr (4:2:0) or Y:Cb:Cr (4:2:2); storing in the RAM of the driving IC to reduce the RAM usage (with compressible data); then transforming the Y:Cb:Cr signals to the three original colors (R, G, B) signal format to output image data.

### BRIEF DESCRIPTION OF THE DRAWINGS

FIG. 1 is a schematic diagram of a conventional method of storing RAM in a driving IC.

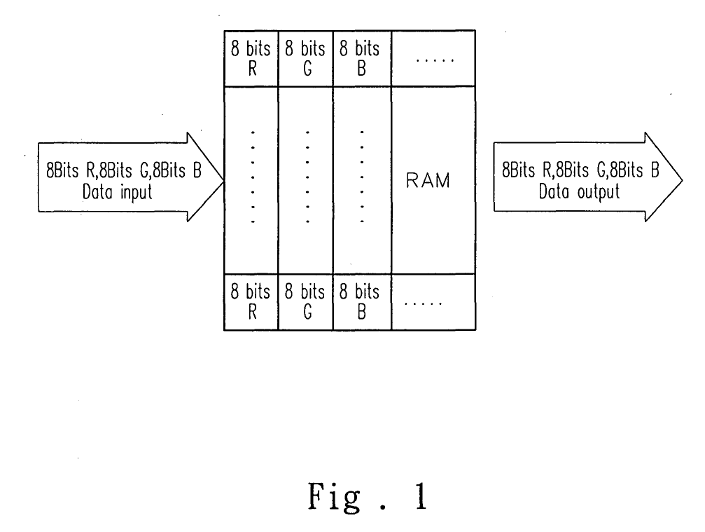

FIG. 2 is a schematic diagram of the method for reducing RAM in the driving IC of display devices according to the present invention.

FIG. 3 is another schematic diagram of the method for reducing RAM in the driving IC of display devices according to the present invention.

### DETAILED DESCRIPTION OF THE PREFERRED EMBODIMENTS

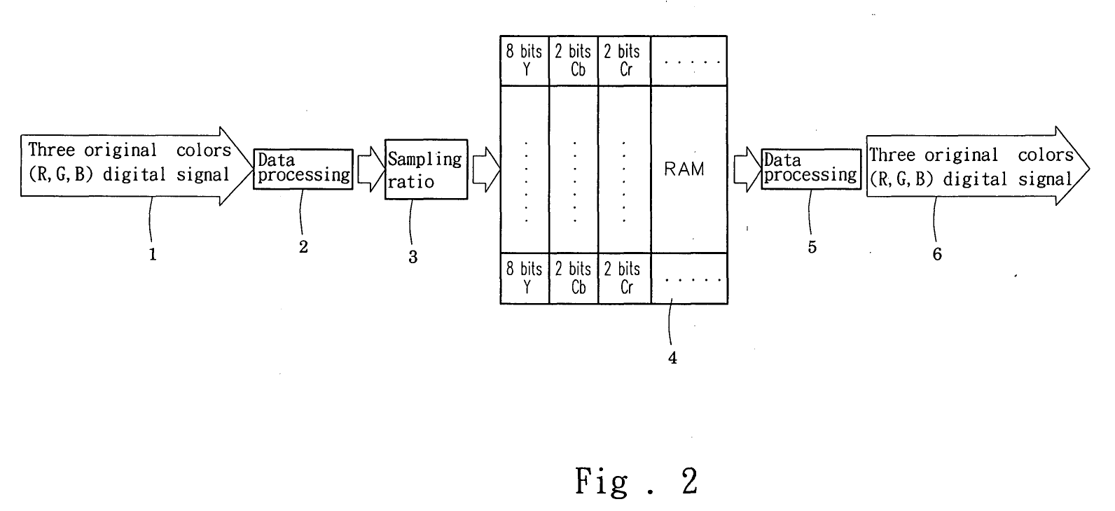

Please referring to FIG. 2, the method for reducing a RAM 4 in the driving IC of display devices according to the present invention includes: transforming graphic data of a digital signal 1 of three original colors (R, G, B) to Y:Cb:Cr digital signals; selecting a sample from two sample ratios Y:Cb:Cr (4:2:0) or Y:Cb:Cr (4:2:2); storing in the RAM 4 of the driving IC at a reduced storage size (with compressed data); transforming the Y:Cb:Cr signals to a digital signal 6 format of three original colors (R, G, B) to output image data.

First, in the driving IC of the display devices, input of image data of a three-original-color (R [symbol] G [symbol] B) digital signal 1 that consists of 8 bits R, 8 bits G and 8 bits B goes through data processing 2 to be transformed to a Y:Cb:Cr signal format. Then a sample ratio 3 is selected to compress data according to MPEG (Motion Pictures Expert Group, which is known in the art, thus details are omitted) Y:Cb:Cr (4:2:0) or Y:Cb:Cr (4:2:2). The compressed data are stored in the RAM 4 of the driving IC. Thus the original data for one pixel that requires storage space of 24 bits may be compressed and reduced to 12 bits. Then the 12 bits of Y, Cb, and Cr data go through data processing 5 to be transformed to a data format of three original color (R, G, B) digital signals 6 to be output.

The image data of the three original-three-color (R [symbol] G [symbol] B) digital signal 1 of 8 bits R, 8 bits G and 8 bits B go through data processing 2 and are transformed to the Y:Cb:Cr (4:2:0) sample ratio 3 format, where calculations of Y, Cb and Cr are as follows:
Y=0.299R+0.587G+0.114B
Cb=−0.168R−0.331G−0.499B
Cr=0.500R−0.419G−0.081B
where R, G and B and Y:Cb:Cr are represented by 24 (8+8+8) bits and are in the range of 0-255, with Y representing the brightness, and Cb and Cr representing color signals.

Based on the Y:Cb:Cr (4:2:0) sample ratio 3 approach and MPEG standards, every point has a brightness valve (Y), and every four points have a color value (Cb and Cr).

Thus a pixel that originally requires 24 bits now requires only 12 bits [=(4×8+8+8)/4](Y:8 bits [symbol] Cb:2 bits [symbol] Cr:2 bits) when the sample ratio is adopted. The resulting 12 bits are stored in the RAM 4.

During output, transform to three original colors (R, G, B) output signals through Y:Cb:Cr based on calculations as follows:
R=Y+1.04020 (Cr−128)
G=Y−0.3441 (Cb−128)−0.7141 (Cr−128)
B=Y+1.07720 (Cb−128)

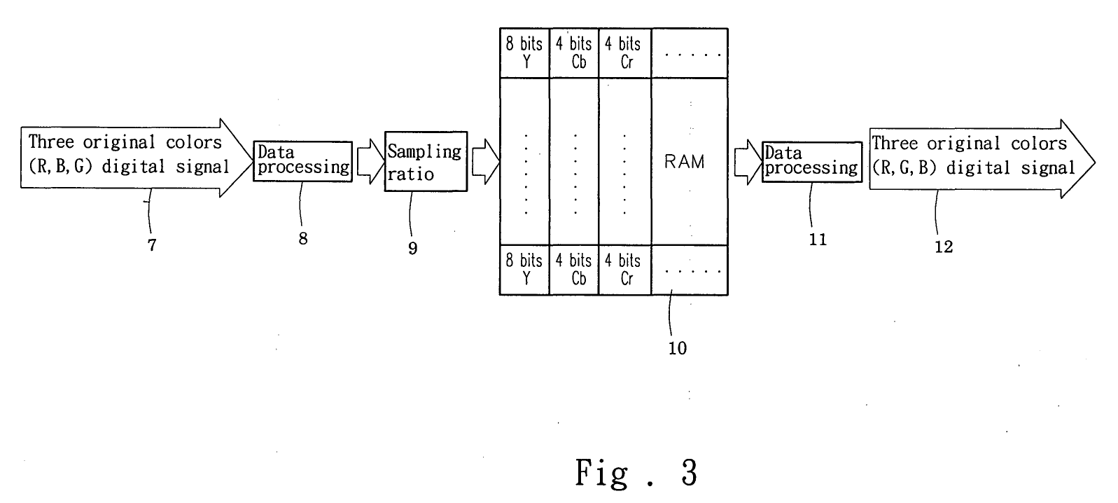

Refer to FIG. 3 for another method for reducing RAM in the driving IC of display devices according to the present invention. As shown in the drawing, in the driving IC of the display devices, input of image data of a three-original-color (R [symbol] G [symbol] B) digital signal 7 that consists of 8 bits R, 8 bits G and 8 bits B goes through data processing 8 to be transformed to a Y:Cb:Cr signal format. Then a sample ratio 9 Y:Cb:Cr (4:2:2) is selected to compress data according to MPEG (Motion Pictures Expert Group, which is known in the art, thus details are omitted). The compressed data is stored in a RAM 10 of the driving IC. Thus the original data for one pixel that requires storage space of 24 bits may be compressed and reduced to 16 bits. Then data processing 11 is performed to transform to a three-original-color (R, G, B) digital signal 12 for outputting.

The image data of the three-original-color digital signal 7 of 8 bits R, 8 bits G and 8 bits B go through data processing 8 to be transformed to Y:Cb:Cr (4:2:2), the Y, Cb and Cr of the sample ratio 9 format are calculated as follows:
Y=0.299R+0.587G+0.114B
Cb=−0.168R−0.331G−0.499B
Cr=0.500R−0.419G−0.081B
where R, G and B and Y:Cb:Cr are represented by 24 (8+8+8) bits and are in the range of 0-255, with Y representing the brightness, and Cb and Cr representing color signals.

Based on the Y:Cb:Cr (4:2:2) sample ratio 9 approach and MPEG standards, every point has a brightness valve (Y), and every four points have two color values (Cb and Cr).

Thus a pixel that originally requires 24 bits now requires only 16 bits [=(4×8+2×8+2×8)/4] (Y:8 bits [symbol] Cb:4 bits [symbol] Cr:4 bits) when the sample ratio is adopted. The resulting 16 bits are stored in the RAM 10.

During output, transform to three original colors (R, G, B) output signals through Y:Cb:Cr based on calculations as follows:
R=Y+1.04020 (Cr−128)
G=Y−0.3441 (Cb−128)−0.7141 (Cr−128)
B=Y+1.7720 (Cb−128)

While the preferred embodiments of the invention has been set forth for the purpose of disclosure, modifications of the disclosed embodiments of the invention as well as other embodiments thereof may occur to those skilled in the art. Accordingly, the appended claims are tended to cover all embodiments which do not depart from the spirit and scope of the invention.

1. A method for reducing a random access memory (RAM) of an integrated circuit (IC) in display devices, comprising:
a. transforming a digital signal graphic data of three original colors (R, G, B) through data processing to a Y, Cb and Cr signal, where Y is a brightness signal and Cr and Cb are color signals;
b. selecting a Y:Cb:Cr sample ratio according MPEG standards and compressing and storing the sample ratio in the RAM of the driving IC; and
c. processing through another data processing to transform the signal stored in the RAM of the driving IC to an original-three-colors (R, G, B) signal format to output image data.

2. The method of claim 1, wherein the sample ratio of Y: Cb Cr at step b is Y:Cb:Cr (4:2:0).

3. The method of claim 1, wherein the sample ratio of Y: Cb Cr at step b is Y:Cb:Cr (4:2:2).
